(19) United States
(12) Patent Application Publication
(10) Pub. No.: US 2013/0103533 A1
(43) Pub. Date: Apr. 25, 2013

(54) Ascertaining a Product Configuration Within a Budget

(71) Applicants: Amitabh Prasad, Yerwada (IN); Cheranellore Vasudevan, Bstrop, TX (US)

(72) Inventors: Amitabh Prasad, Yerwada (IN); Cheranellore Vasudevan, Bstrop, TX (US)

(73) Assignee: International Business Machines Corporation, Armonk, NY (US)

(21) Appl. No.: 13/277,628

(22) Filed: Oct. 20, 2011

(51) Int. Cl. G06Q 30/06

(52) U.S. Cl. 705/26.5

(57) ABSTRACT

Embodiments of the invention relate to product configuration and product augmentation with replaceable components. One or more replaceable components are identified and sorted, and a tolerance factor is assessed for deviation from price and function. Replacement parts are identified for the replaceable components, and a product configuration employing at least one of the replacement parts is validated with respect to both the price and functional deviation. Responsive to the validation, a validated replacement system is configured.

### BACKGROUND

1. Technical Field

The present invention relates to a method and system for providing guidance with respect to building a configurable product. More specifically, the invention relates to a system and method that provides a product configuration with functional replacement parts while adhering to identified budgetary constraints.

2. Description of the Prior Art

It is understood that many products are comprised of a combination of components that function as a whole to support the product. When configuring a product, it is important that the components of the product be compatible to support the product configuration and functionality. Product components are selected for various reasons, including pre-requisites, co-requisites, sales influence, etc. Accordingly, compatibility of the selected components is critical to support the final product.

### SUMMARY OF THE INVENTION

This invention comprises a method, system, and apparatus for product configuration that balances component compatibility together with adherence to budgetary restrictions.

In one aspect of the invention, a method is provided for guiding a user to select a valid combination of parts to build a customized system comprised of a plurality of components. More specifically, the method addresses identification of equivalent system components that match the desired system while adhering to budgetary constraints. The method addresses identifying all configurable elements of the system, filtering all parts that should not be replaced, hereinafter referred to as non-replacement parts, including identifying replacement parts, and sorting the identified replacement parts based on priority and price. Following the above-outlined steps, tolerance of the sorted replacement parts to both budget and functional deviation is assessed. Based upon the assessments, a product configuration is validated, together with a price for the validated product configuration. Finally, a replacement system is configured, with the replacement system closely matching the desired system with a validated final product configuration and price.

In another aspect, a system is provided with a processor in communication with memory. A functional unit is provided in communication with the memory and includes tools to support building a system having multiple components, including adhering to restrictions of component compatibility, performance, and price. The tools of the functional unit include, but are not limited to, a guidance manager, an assessment manager, a validation manager, and a configuration manager. The guidance manager functions to guide a user to select a valid combination of parts to build a customized system having a plurality of components; the guidance manager identifies equivalent system components that match the desired system functionality while limited to a budgetary constraint. More specifically, the guidance manager identifies all configurable elements of the system, filters non-replacement parts, identifies replacement parts, and sorts the identified replacement parts based upon priority or price. The assessment manager, which is in communication with the guidance manager, functions to assess tolerance of the sorted replacement parts to a budget or function deviation. The validation manager, which is in communication with the assessment manager, functions to validate a product configuration based upon the deviation assessed by the assessment manager. More specifically, the validation manager functions to validate a price for the validated product configuration. The configuration manager, which is in communication with the validation manager, functions to configure a replacement system to closely match the desired system with a final validated product configuration and price.

In yet another aspect, a computer program product is provided. The computer program product includes a computer-readable storage medium having computer readable program code embodied thereon, which when executed causes a computer to implement a method for guiding selection of a valid combination of parts to build a customized system comprised of a plurality of components. The selection guidance includes identifying equivalent system components that match the desired system while adhering to a set of budgetary constraints. The program code includes instructions to: identify all configurable elements of the system, filter non-replacement parts, including identification of replacement parts, and sort the identified replacement parts based on priority and price. In addition, program code is provided to assess tolerance of the sorted replacement parts to deviation of both budget and function, to validate a product configuration based upon the assessed tolerance, and to validate a price for the validated product configuration. In response to the validation includes, program code is provided to configure a replacement system that closely matches the desired system with a validated final product configuration and price.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 depicts a flow chart illustrating a process for presenting product configuration options together with addressing elements of a multi-component system and component equivalency.

FIG. 2 depicts a flow chart illustrating a process for calculating component equivalency for a processor core as a designated replacement component of a computer system.

FIGS. 3A and 3B depict a flow chart illustrating a process for assessing component equivalency.

FIG. 4 depicts a block diagram illustrating a chart for replacement models.

FIG. 5 depicts a block diagram illustrating a chart for identifying replacement parts for two of the replaceable components identified in FIG. 4.

FIG. 6 depicts a block diagram illustrating tools embedded in a computer system to support configuration of a replacement system while maintaining performance and function within a defined limit of tolerance.

FIG. 7 depicts a flow chart illustrating a process for loading the log from storage and parsing the continuous log for one or more select threads.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit described in this specification has been labeled with tools, modules, and/or managers. The functional unit may be implemented in programmable hardware devices such as field programmable gate arrays, programmable array logic, programmable logic devices, or the like. The functional unit may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of modules, managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention.

The art of selecting components of a configurable product is challenging both with respect to engineering a final functional product and addressing budgetary concerns. A configured product that exceeds an established budget for purchase of the product is not optimal. In the end, the product must be able to sell and be sold. A tool that can illustrate two or more similar product configuration that identifies differences with respect to function and price is beneficial for attaining a balance between price and performance. For purposes of description the configurable product is referred to herein as a system with multiple components. Each of the components in the system are referred to as a replaceable component or a non-replaceable component. A part employed as a substitute for a replaceable component is referred to herein as a replaceable part.

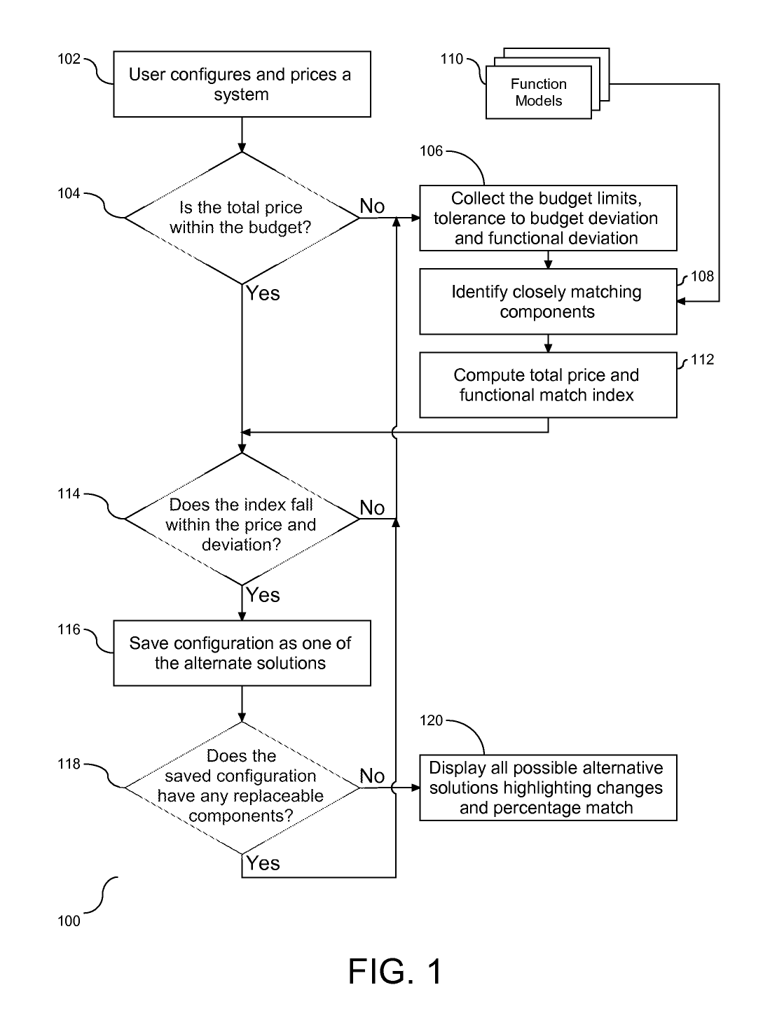

FIG. 1 is a flow chart (100) illustrating a high level of presenting product configuration options together with addressing elements of a multi-component system and component equivalency. As shown, a user configures a system and attains a price for the system configuration (102). Whether the system is configured for a commercial or non-commercial environment, there is always a budget that is assigned to a final system configuration. Based upon this premise, following the configuration at step (102), it is then assessed if the price returned at step (102) fits within a budget established for the system configuration (104). A positive response to the determination at step (104) concludes the product configuration process with respect to price. However, a negative response to the determination at step (104) introduces steps to address adjustment of the product configuration to meet the budget. Accordingly, the first part of the system configuration addresses budgetary restrictions for component replacement.

The first step in addressing the budget is to collect the budget limit together with any associated tolerance deviation (106). More specifically, at step (106) information is gathered for tolerances with respect to budget and function. In one embodiment, the tolerance may be zero, indicating that there is no support for deviation from product function or price. Similarly, in one embodiment, the tolerance may be a percentage value. In another embodiment, the tolerance may be bifurcated to include a tolerance value for budget and a tolerance value for function that is separate from that set for budget. Accordingly, the product configuration budget and tolerance values may be a set value or a configurable value.

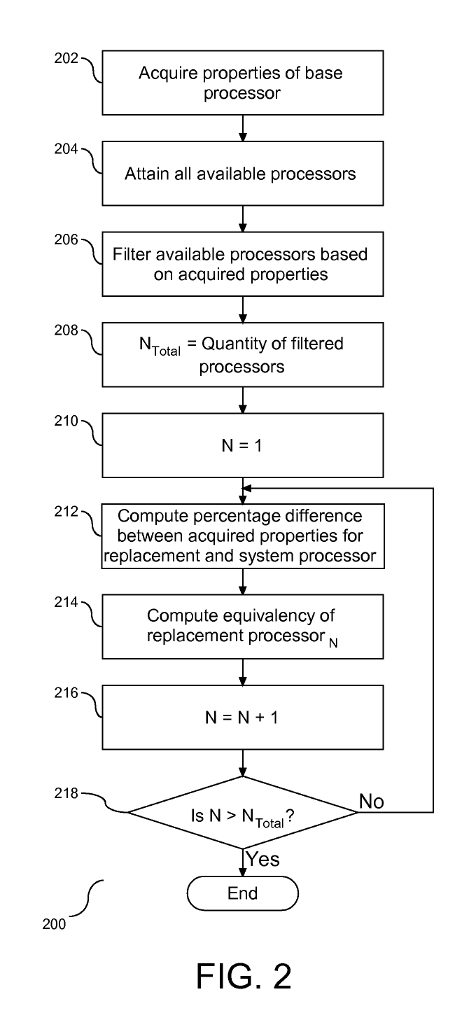

Following step (106), closely matching product components are identified (108). Details of the process for identifying and calculating component equivalency are shown in FIG. 2. More specifically, the calculating component equivalency is received as input at step (110). Based upon the budget limits collected at step (106) and the identified equivalent components at step (108), a price and functional match index is computed for all system components, including new replacement parts and prior existing parts that comprise the current system (112). Among the criteria for the component assessment is price and function. Accordingly, the final system price must adhere to an established budget, or in one embodiment, within a specified standard of deviation of the established budget.

Following step (112), it is determined if the computed index for the configured system falls within a specified price and deviation from a base value (114). A negative response to the determination at step (114) is followed by a return to step (106). However, a positive response to the determination at step (114) is an indication that at least one product configuration adheres to the specified functional and budgetary constraints, and this product configuration is saved as at least one alternate product solution (116). Accordingly, each product configuration must adhere to both function and budget in order to be considered as a configuration solution.

As shown herein, a new system configuration that is compatible with and adheres to established function and budget constraints may be created and saved as a product solution. However, there may be multiple product solutions. More specifically, for each product solution different combinations of replacement parts may exist, with each combination yielding a different system configuration that may or may not adhere to the system function and budget. As such, following step (116) it is determined if the configuration saved at step (116) has any replaceable components (118). A positive response to the determination at step (118) is followed by a return to step (106) for creation of at least one more system configuration followed by an assessment of the system with respect to function and budget. Conversely, a negative response to the determination at step (118), concludes the creation of system configuration. Each of the saved system configurations are presented (120). In one embodiment, the presentation at step (120) includes identification of differences among the configurations and the computed index from step (112) of each system configuration. Accordingly, one or more system configurations may be saved as alternate system configurations, with each alternate configuration having an associated computed index demonstrating a price and function deviation.

Various factors are employed for creating an alternate system configuration, including but not limited to, component compatibility. More specifically, creation of an alternate system configuration requires replacement parts that support the functionality of the original part that is being replaced. It is known and understood that although a part may be replaceable, the replacement may not function as an exact replacement. The functional quality of a replacement part is an important factor to assess and consider. Accordingly, each replacement part contains a function attribute that is identified to assess the effect of a given functional quality.

Other factors for replacement parts are also considered, including the price of each replacement part and priority. Each replacement part has an associated cost, and this cost must be included to address meeting a system budget. The priority identifies and prioritizes different system components. Each replacement part is prioritized with respect to other replacement parts to assign a level of importance with respect to a specific component. In one embodiment, not all components of the system may be replaceable. Certain components may be designated as non-replaceable. Accordingly, each configurable component is designated as replaceable or non-replaceable, with the designated replaceable components assigned a respective priority.

As shown in FIG. 1, one of the aspects of creating a replacement system configuration is to address equivalency of replacement components. FIG. 2 is a flow chart (200) illustrating a process for calculating component equivalency for a processor core as a designated replacement component of a computer system. Initially, the base processor properties are acquired (202). These properties include, but are not limited to, number of cores, clock speed, cache, bus, etc. Following the acquisition at step (202), all available processors are attained (204) and then filtered based upon one or more of the acquired properties (206). The quantity of filtered processors is assigned to the variable N_{Total} (208), and an associated counting variable, N, is assigned to the integer one (210). For each processor_{N}, the percentage difference between the acquired properties for the replacement processor and the system processor is computed (212). In addition, the equivalency of the replacement processor_{N} is computed (214). Following the computations at step (212) and (214), the variable N is incremented (216). It is then determined if each of the filtered processors have been evaluated (218). A negative response to the determination at step (218) is followed by a return to step (212). Conversely, a positive response to the determination at step (218) concludes the component equivalency assessment.

FIG. 2 shown above is illustrated with respect to replacement of a processor for a computer system. However, in one embodiment, the replacement component for a computer system may be any configurable computer component that has been designated as replaceable. Accordingly, the scope of the invention should not be limited to replacement of a processor as a computer system component.

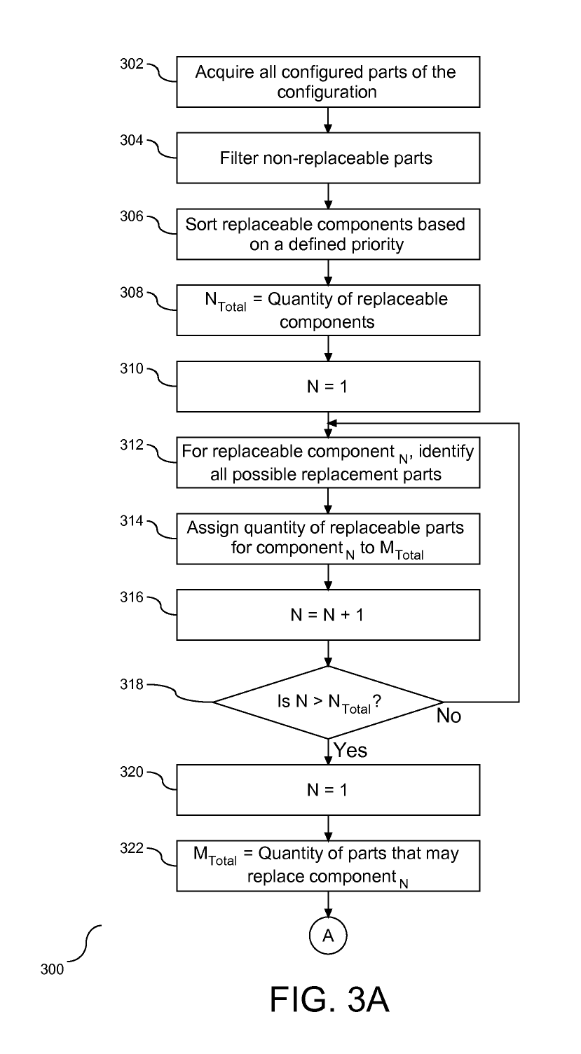

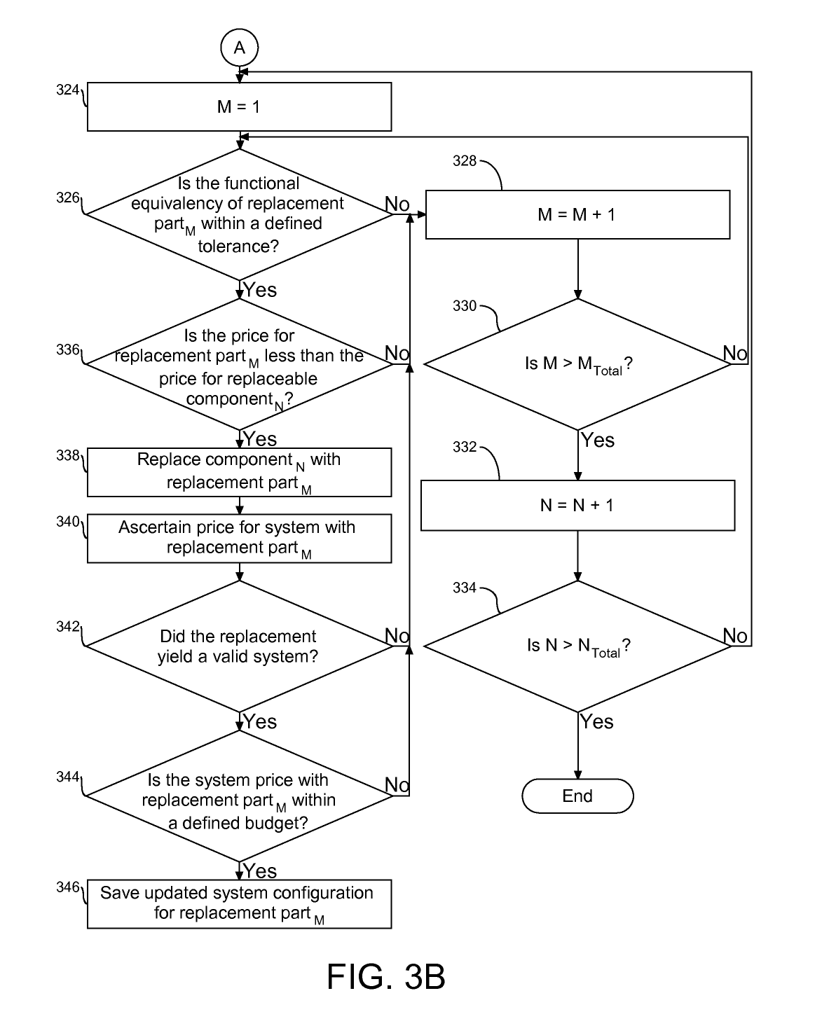

In the flow charts illustrated above, there is a theme pertaining to components of a system that are designated as replaceable or non-replaceable. A non-replaceable component remains as a static element of the system. In contrast, a non-replaceable component is compared with components deemed to be equivalent. FIGS. 3A and 3B are a flow chart (300) illustrating a process for assessing component equivalency. All of the configured parts of the system are acquired (302) from which the non-replaceable components are filtered (304). With only the designated replaceable components remaining under consideration, the replaceable components are sorted based upon a defined priority (306). More specifically, the replaceable components are prioritized and sorted in either an ascending or descending order based upon the associated priority. An example of component prioritization is shown in detail in FIG. 4. Accordingly, the first part of the equivalency assessment filters the non-replaceable system components so that the algorithm is limited to those components that may be replaced.

The variable N_{Total} is assigned to the quantity of replaceable components (308), and an associated counting variable N is assigned to the integer one (310). For replaceable component_{N}, all possible replacement parts are identified (312) and the quantity of replacement parts for component_{N} is assigned to the variable M_{Total} (314). Following step (314), the variable N is incremented (316) followed by determining if all of the replaceable components have been evaluated (318). A negative response to the determination at step (318) is followed by a return to step (312) for further identification of replaceable parts. In contrast, a positive response to the determination at step (318) concludes the aspect of identified replacement parts for a designated system component. Accordingly, the first part of the equivalency determination address identification of replacement parts.

For each replaceable system component, one or more replacement parts are identified. The counting variable N for the replaceable component is assigned to the integer one (320), and the variable M_{Total} is assigned to represent the quantity of parts that may replace component_{N} (322). Following the assignment at step (322), a counting variable M is assigned to the integer one (324). Thereafter, it is determined if the functional equivalency of replacement part_{M} is within a defined tolerance (326). A negative response to the determination at step (326) is followed by an increment of the counting variable M (328) and determining if all of the replacement parts have been evaluated (330). A negative response to the determination at step (330) is followed by a return to step (326), and a positive response to the determination at step (330) concludes the evaluation of replacement parts for each replaceable component. More specifically, the counting variable N for replaceable components is incremented (332), followed by determined if all of the replaceable components have been evaluated (334). A negative response to the determination at step (334) is followed by a return to step (324). Conversely, a positive response to the determination at step (334) concludes the equivalency evaluation process. Accordingly, for each determined replacement component, a quantity of replacement parts are identified, sorted, and evaluated.

As shown at step (326), one of the tests of equivalency pertains to a defined tolerance. If the replacement part_{M} being evaluated falls within the defined tolerance at step (326), it is determined if the price for replacement part_{M} is less than the price for replaceable component_{N} (336). A negative response to the determination at step (336) is followed by a return to step (328). Conversely, a positive response to the determination at step (336) is followed by replacing component_{N} with replacement part_{M} (338) and ascertaining a price for the system with the replacement part_{M} (340). Following step (340), it is determined if the replacement at step (338) yielded a valid system configuration (342). More specifically, the determination at step (342) is a final validation to assess whether the complete product configuration is acceptable. A positive response to the determination at step (342) is followed by determining if a system price with the replacement part(s) is within a defined budget (344). More specifically, the determination at step (344) is a final price check for the replacement part_{M}. A negative response to the determinations at steps (342) or (344) is followed by a return to step (328). However, a positive response to the determination at step (344) is followed by saving the updated system configuration for replacement part_{M} (346). Since all of the replacement parts for a replaceable component are evaluated, following step (346) the process returns to step (328). Accordingly, for each replacement part of each replaceable component equivalency is evaluated, including but not limited to, functional tolerance, price, validity and budget.

As shown in FIGS. 3A and 3B, replacement components are identified, together with one or more replacement parts for each component. FIG. 4 is a block diagram (400) illustrating a chart for replacement models. The chart is one embodiment for illustrating replacement models, and the invention should not be limited to this embodiment. As shown, there are four columns, with a first column (410) representing a product, a second column (420) representing a component identifier, a third column (430) representing a priority for replacement of the product, and a fourth column (440) representing conditions for replacement. More specifically, the chart shows which parts are replaceable and in which order replacement should be attempted. The priority, as referenced in the second column (420), may be based upon different factors, including aspects of importance and optional parts. Based upon the example shown herein, only three components (460), (462), and (464) are identified as replaceable. In one embodiment, the priority may be controlled by dynamic conditions of the current system configuration. As shown in this example, there is a designation in the priority column for a part that is not replaceable. Accordingly, the chart shown herein is a tool to organize information pertaining to replacement components.

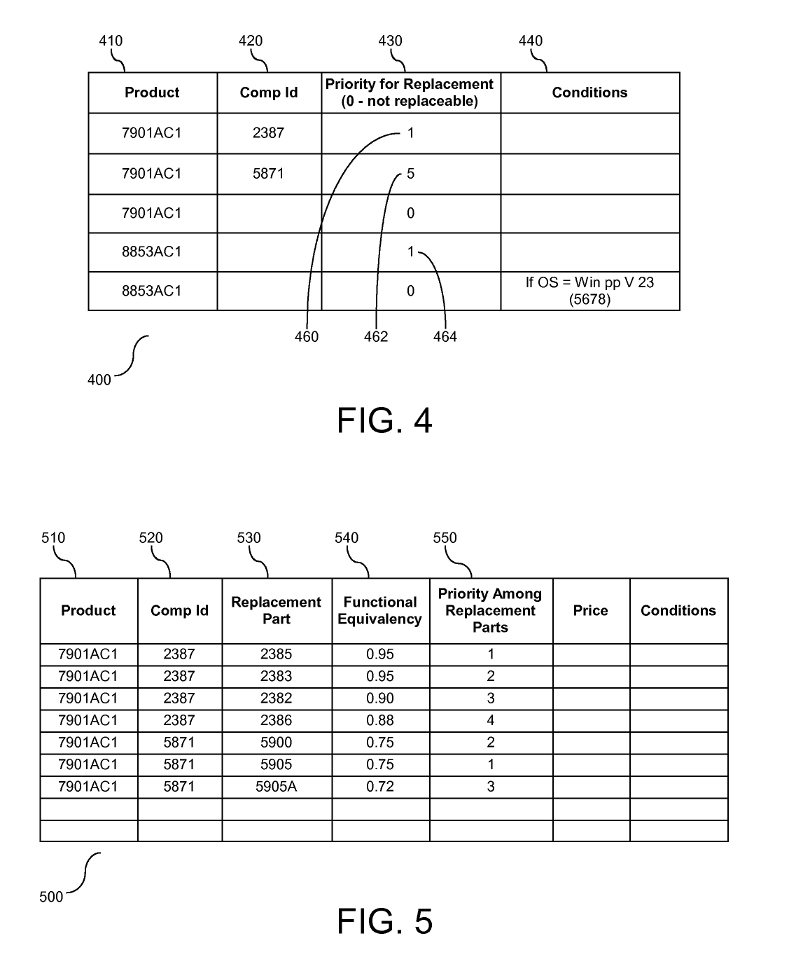

In a multiple component system, some or all of the components may be replaced with a replacement part. As shown in FIGS. 1-3B, different methods are employed to evaluate aspects of the replaceable component together with aspects of replacement parts. FIG. 5 is a block diagram (500) illustrating a chart for identifying replacement parts for two of the replaceable components (460) and (462) identified in FIG. 4. More specifically, the chart identifies the product (510), the component identifier (520), a replacement part (530), a functional equivalency (540), and a priority among replacement parts (550). For a particular product component, there may be more than one equivalent replacement part. Where there are multiple replacement parts, there may be an associated relative priority of one or more of the replacement parts, as shown as (550). The priority shown at (550) may be sorted based upon the assigned numerical identifier. In one embodiment, the associated relative priority may be dictated by how close the functional equivalence the replacement part is to the component being replaced. Similarly, in one embodiment, the priority of replaceable component may be dependent on the dynamic content of the system configuration.

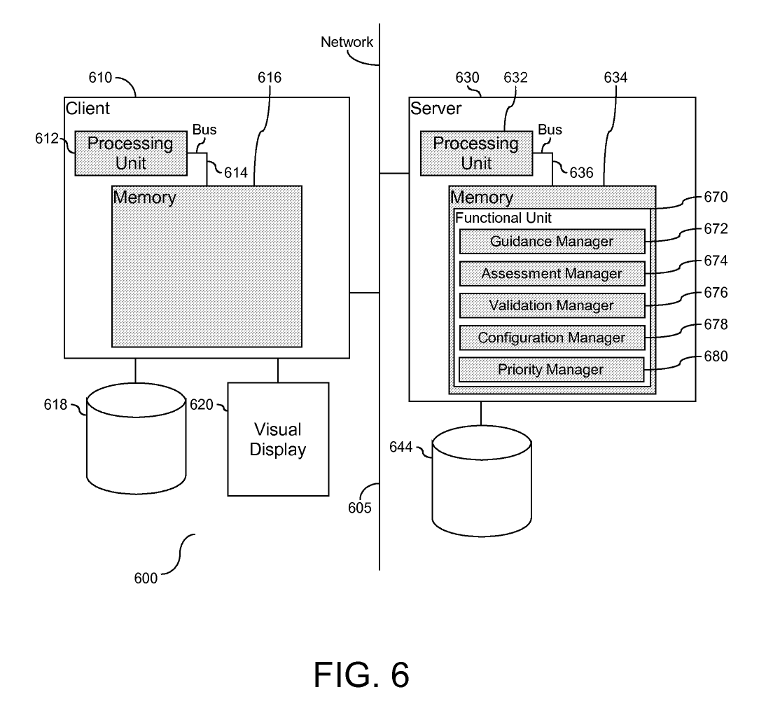

The evaluation of product components with replacement parts for a multi-component products supports creating a system with perhaps less costly parts while maintaining the functional level of operation of the system. FIG. 6 is a block diagram (600) illustrating tools embedded in a computer system to support configuration of a replacement system while maintaining performance and function within a defined limit of tolerance. For illustrative purposes, a computer system is provided with a client machine (610) in communication with a server (630) across a network (605). The client machine (610) is provided with a processing unit (612) in communication with memory (616) across a bus (614). In one embodiment, client machine (610) is in communication with local data storage (618) and a visual display (620).

The client machine (610) is shown in communication with the server (630) across the network (605). In one embodiment, the server (630) is provided with a processing unit (632) in communication with memory (634) across a bus (636). As shown herein, the server (630) is in communication with at least one storage device (644) and a visual display (646). In one embodiment, the server (630) may be in communication with additional storage devices, and/or additional data centers. The storage device (644) is configured to support read and/or write operations.

A functional unit (670) is provided in communication with memory (634); the functional unit (670) supports configuration of a multi-component product with at least one of the components designated as supporting replacement with a replaceable part. As shown, the functional unit (670) is provided with a guidance manager (672), an assessment manager (674), a validation manager (676), a configuration manager (678), and a priority manager (680). The guidance manager (672) functions to guide selection of a valid combination of parts to build a customized system that has multiple components. More specifically, the guidance manager (672) identifies all configurable elements of the system, filters non-replacement system parts, identifies replacement parts, and sorts the identified replacement parts based upon a priority or price identifier. Accordingly, the guidance manager functions to identify equivalent system components that match the functionality of the desired system, while adhering to a budgetary constraint established for cost of the multi-component system.

The assessment manager (674) is provided in communication with the guidance manager (672). More specifically, the assessment manager assesses tolerance of the sorted replacement parts to function deviation or a budget deviation. The validation manager (676) is provided in communication with the assessment manager (674). The validation manager functions to validate a product configuration and price. Specifically, the product configuration is assessed based upon the deviation as assessed by the assessment manager (674) as well as price for the validated product configuration. The priority manager (680), which is in communication with the validation manager (676), functions to dynamically control prioritization of the replaceable parts, with the prioritization based upon product content configuration. In one embodiment, the validation manager (676) identifies a closely functionally equivalent system within the confines of a budgetary limit.

The configuration manager (678), which is also in communication with the validation manager (676), functions to configure a replacement system that closely matches the desired system. The configuration manager (678) identifies functional equivalency for a replacement part, including a functional equivalence metric and prioritization for an identified component. In one embodiment, the configuration manager (678) computes a percentage of equivalency of a candidate replacement part based upon a physical attribute or a functional attribute. A final validated product configuration and price is returned by the configuration manager (678). Accordingly, the managers function as tools within a unit to support system design and configuration within a set of parameters to maintain a level of functionality of the final product together with attainment of a budget.

As identified above, the guidance manager (672), assessment manager (674), validation manager (676), configuration manager (678), and priority manager (680), hereinafter referred to as tools, function as elements to support system configuration with one or more functional and/or budgetary equivalent replacement parts. The tools (672)-(680) are shown residing in memory (634) local to the server (630). However, the tools (672)-(680) may reside as hardware tools external to memory (634), or they may be implemented as a combination of hardware and software. Similarly, in one embodiment, the tools (672)-(680) may be combined into a single functional item that incorporates the functionality of the separate items. As shown herein, each of the tools (672)-(680) are shown local to the server (630). However, in one embodiment they may be collectively or individually distributed across a network or multiple machines and function as a unit to evaluate hardware performance. Accordingly, the tools may be implemented as software tools, hardware tools, or a combination of software and hardware tools.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

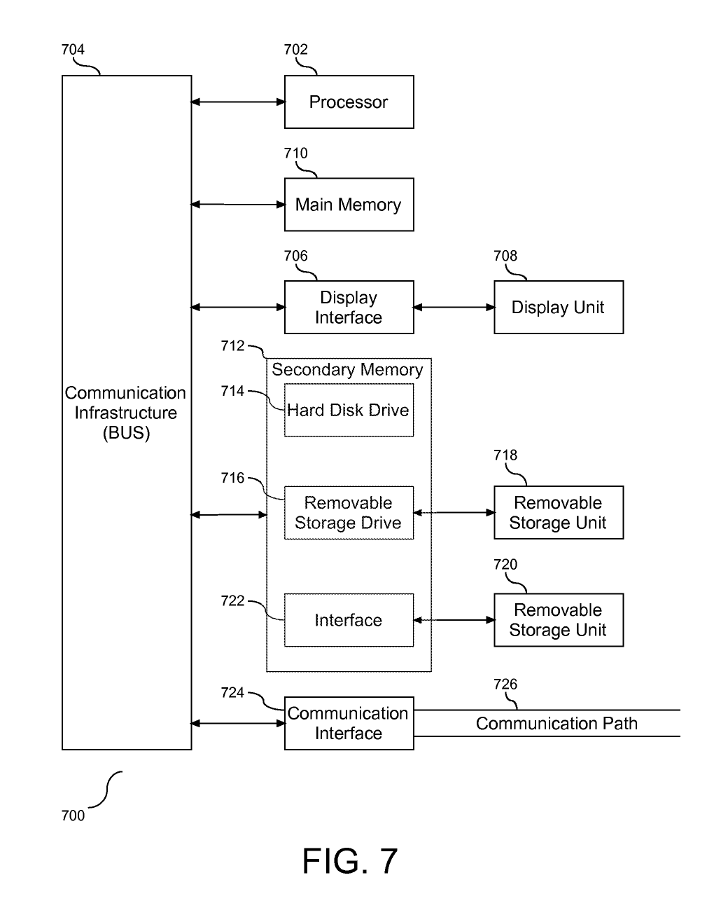

Referring now to the block diagram of FIG. 7, additional details are now described with respect to implementing an embodiment of the present invention. The computer system includes one or more processors, such as a processor (702). The processor (702) is connected to a communication infrastructure (704) (e.g., a communications bus, cross-over bar, or network).

The computer system can include a display interface (706) that forwards graphics, text, and other data from the communication infrastructure (704) (or from a frame buffer not shown) for display on a display unit (708). The computer system also includes a main memory (710), preferably random access memory (RAM), and may also include a secondary memory (712). The secondary memory (712) may include, for example, a hard disk drive (714) and/or a removable storage drive (716), representing, for example, a floppy disk drive, a magnetic tape drive, or an optical disk drive. The removable storage drive (716) reads from and/or writes to a removable storage unit (718) in a manner well known to those having ordinary skill in the art. Removable storage unit (718) represents, for example, a floppy disk, a compact disc, a magnetic tape, or an optical disk, etc., which is read by and written to by removable storage drive (716). As will be appreciated, the removable storage unit (718) includes a computer readable medium having stored therein computer software and/or data.

In alternative embodiments, the secondary memory (712) may include other similar means for allowing computer programs or other instructions to be loaded into the computer system. Such means may include, for example, a removable storage unit (720) and an interface (722). Examples of such means may include a program package and package interface (such as that found in video game devices), a removable memory chip (such as an EPROM, or PROM) and associated socket, and other removable storage units (720) and interfaces (722) which allow software and data to be transferred from the removable storage unit (720) to the computer system.

The computer system may also include a communications interface (724). Communications interface (724) allows software and data to be transferred between the computer system and external devices. Examples of communications interface (724) may include a modem, a network interface (such as an Ethernet card), a communications port, or a PCMCIA slot and card, etc. Software and data transferred via communications interface (724) are in the form of signals which may be, for example, electronic, electromagnetic, optical, or other signals capable of being received by communications interface (724). These signals are provided to communications interface (724) via a communications path (i.e., channel) (726). This communications path (726) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (710) and secondary memory (712), removable storage drive (716), and a hard disk installed in hard disk drive (714).

Computer programs (also called computer control logic) are stored in main memory (710) and/or secondary memory (712). Computer programs may also be received via a communication interface (724). Such computer programs, when run, enable the computer system to perform the features of the present invention as discussed herein. In particular, the computer programs, when run, enable the processor (702) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. More specifically, the details herein pertain to a multi-component computer system with replaceable components. In one embodiment, the multi-component system may be a non-computer based system comprised of multiple components that are replaceable. Accordingly, the scope of protection of this invention is limited only by the following claims and their equivalents.

We claim:

1. A method comprising:
guiding a user to select a valid combination of parts to build a customized system having a plurality of components, including identifying equivalent system components that match the desired system while limited to a set of budgetary constraints, including:
identifying all configurable elements of the system;
filtering non-replacement parts, including identifying replacement parts; and
sorting the identified replacement parts based on priority and price;
assessing tolerance of the sorted replacement parts to budget deviation and to functional deviation;
validating a product configuration based upon the assessment for both budget and functional deviation;
validating a price for the validated product configuration; and
configuring a replacement system that closely matches the desired system with a validated final product configuration and price.

2. The method of claim 1, further comprising dynamically controlling prioritization of replaceable parts based on product content configuration.

3. The method of claim 1, further comprising identifying functional equivalency for a replacement part.

4. The method of claim 3, further comprising computing a percentage of equivalency of a candidate replacement part based on functional and physical attributes.

5. The method of claim 3, wherein identifying functional equivalency includes capturing a functional equivalence metric and prioritization for an identified component.

6. The method of claim 1, wherein identifying all configurable elements includes one or more replacement system components.

7. The method of claim 1, wherein validating product configuration and price includes identifying a closely functionally equivalent system dictated by budgetary limits.

8. A system comprising:
a processing unit in communication with memory;
a functional unit a functional unit in communication with memory, the functional unit comprising:
a guidance manager to guide a user to select a valid combination of parts to build a customized system having a plurality of components, the guidance manager to identify equivalent system components that match the desired system functionality while limited to a budgetary constraint;
the guidance manager to:
identify all configurable elements of the system;
filter non-replacement parts and identify replacement parts; and
sort the identified replacement parts based on an identifier selected from the group consisting of: priority and price;
an assessment manager in communication with the guidance manager, the assessment manager to assess tolerance of the sorted replacement parts to a deviation selected from the group consisting of: budget and function;
a validation manager in communication with the assessment manager, the validation manager to validate a product configuration based upon the deviation assessed by the assessment manager, the validation manager to validate a price for the validated product configuration; and
a configuration manager in communication with the validation manager, the configuration manager to configure a replacement system to closely match the desired system with a final validated product configuration and price.

9. The system of claim 8, further comprising a priority manager in communication with the validation manager, the priority manager to dynamically control prioritization of one or more replaceable parts based on product content configuration.

10. The system of claim 8, further comprising the configuration manager to identify functional equivalency for a replacement part.

11. The system of claim 10, further comprising the configuration manager to compute a percentage of equivalency of a candidate replacement part based on an attribute selected from the group consisting of: functional and physical.

12. The system of claim 10, wherein identification of functional equivalence includes a functional equivalence metric and prioritization for an identified component.

13. The system of claim 8, wherein the guidance manager identification of all configurable elements includes one or more replacement system components.

14. The system of claim 8, wherein the validation manager identifies a closely functionally equivalent system dictated by a budgetary limit.

15. A computer program product comprising a computer readable storage medium having computer readable program code embodied therewith, the computer readable program code comprising:
computer readable program code configured to guide a user to select a valid combination of parts to build a customized system having a plurality of components, including identifying equivalent system components that match the desired system while limited to a set of budgetary constraints, including:
identifying all configurable elements of the system;
filtering non-replacement parts, including identifying replacement parts; and
sorting the identified replacement parts based on priority and price;
computer readable program code configured to assess tolerance of the sorted replacement parts to budget deviation and to functional deviation;
computer readable program code to validate a product configuration based upon the assessment for both budget and functional deviation;
computer readable program code to validate a price for the validated product configuration; and
computer readable program code to configure a replacement system that closely matches the desired system with a validated final product configuration and price.

16. The computer program product of claim 15, further comprising computer readable program code configured to dynamically control prioritization of replaceable parts based on product content configuration.

17. The computer program product claim 15, further comprising computer readable program code configured to identify functional equivalency for a replacement part.

18. The computer program product of claim 17, further comprising computer readable program code configured to compute a percentage of equivalency of a candidate replacement part based on functional and physical attributes.

19. The computer program product of claim 17, wherein the code to identify functional equivalency includes capturing a functional equivalence metric and prioritization for an identified component.

20. The computer program product of claim 15, wherein the code to identify all configurable elements includes one or more replacement system components.

21. The computer program product of claim 15, wherein the code to validate product configuration and price includes identifying a closely functionally equivalent system dictated by budgetary limits.
